(19) United States
(12) Patent Application Publication
(10) Pub. No.: US 2024/0210744 A1
(43) Pub. Date: Jun. 27, 2024

(54) Optically Isotropic Piezoelectric Resonant Collinear Acousto-Optic Modulator

(71) Applicant: The Board of Trustees of the Leland Stanford Junior University, Stanford, CA (US)

(72) Inventors: Okan Atalar, Palo Alto, CA (US); Amir H. Safavi-Naeini, Palo Alto, CA (US); Mohammad Amin Arbabian, San Francisco, CA (US)

(21) Appl. No.: 18/429,005

(22) Filed: Jan. 31, 2024

Related U.S. Application Data
(63) Continuation-in-part of application No. 16/971,127, filed on Aug. 19, 2020.
(60) Provisional application No. 63/442,364, filed on Jan. 31, 2023.
(60) Provisional application No. 62/659,871, filed on Apr. 19, 2018.
(60) Provisional application No. 62/750,534, filed on Oct. 25, 2018.

(51) Int. Cl. G02F 1/11; G02F 1/01; G02F 1/355; H04N 23/50

(52) U.S. Cl. CPC G02F 1/11; G02F 1/0136; G02F 1/3556; H04N 23/50

(57) ABSTRACT

Improved optical modulation is provided in materials which are both piezoelectric and optically isotropic. This enables an acousto-optic modulator configuration with a longitudinal interaction geometry for the optical and acoustic waves which also provides a large acceptance angle. Preferably, the acoustic modulation is at a frequency that corresponds to a mechanical resonance of the modulator window.

### CROSS REFERENCE TO RELATED APPLICATIONS

This application claims the benefit of U.S. provisional patent application 63/442,364, filed on Jan. 31, 2023, and hereby incorporated by reference in its entirety.

This application is a continuation-in-part of U.S. application Ser. No. 16/971,127, filed on Aug. 19, 2020, and hereby incorporated by reference in its entirety.

application Ser. No. 16/971,127 is a national stage entry of application PCT/US2019/028345, filed on Apr. 19, 2019, and hereby incorporated by reference in its entirety.

Application PCT/US2019/028345 claims the benefit of U.S. provisional patent application 62/659,871, filed on Apr. 19, 2018, and hereby incorporated by reference in its entirety.

Application PCT/US2019/028345 claims the benefit of U.S. provisional patent application 62/750,534, filed on Oct. 25, 2018, and hereby incorporated by reference in its entirety.

### GOVERNMENT SPONSORSHIP

None.

### FIELD OF THE INVENTION

This invention relates to optical modulation.

### BACKGROUND

Free-space acousto-optic modulators are commonly used to control the properties of light beams, including but not limited to intensity and polarization. Dynamic control over the properties of light is achieved by applying a radio frequency (RF) source to the modulator, whereby the piezoelectric effect is used to convert the RF source energy into acoustic energy, and subsequently the acoustic wave is used to modulate light propagating through the modulator via the photoelastic effect.

The acceptance angle of a free-space acousto-optic modulator is critical for many applications, especially those concerning imaging or sensing. Acousto-optic modulators using anisotropic materials (e.g., lithium niobate, lithium tantalate, barium titanate, potassium titanyl phosphate) have inherently limited acceptance angles due to the optical birefringence of the acousto-optic interaction medium (here, we refer to the capability to modulate an angle of incident rays incident on the acousto-optic modulator simultaneously as the acceptance angle). For example, in acousto-optic tunable filters constructed from anisotropic materials, the phase-matching condition, and therefore the incident light angle modulated, could be tuned sequentially through adjusting the RF source frequency. Being able to simultaneously modulate a range of incident angles to the modulator is not possible with optical modulators constructed using optically anisotropic materials.

State-of-the art acousto-optic modulators that can achieve a high acceptance angle rely on the bonding of a piezoelectric transducer to a completely isotropic material to achieve a high acceptance angle (since completely isotropic materials do not exhibit the piezoelectric effect). Here we distinguish between optical isotropy (isotropic optical properties) and complete isotropy (all physical properties are isotropic). To improve the modulation efficiency (and therefore to reduce the required drive power), mechanically resonant designs are commonly used in photoelastic modulators, where the dimensions of the modulator determine the mechanical resonant frequency, and the piezoelectric transducer bonded to the photoelastic material is driven at the fundamental mechanical resonant frequency of the modulator to improve the modulation efficiency. However, this implementation comes at the expense of a costly assembly and a fundamental trade-off between the operating frequency and the input aperture for the modulator.

Existing acousto-optic modulators that use completely isotropic materials to achieve a high acceptance angle (e.g., photoelastic modulators) have an inherent trade-off between resonant frequency (i.e., modulation frequency) and the active aperture (for a light beam to propagate through). This is because the piezoelectric transducer is bonded to the side of the photoelastic material to use a transverse interaction geometry between the acoustic wave and light, leading to an inherent trade-off between the resonant frequency of the fundamental acoustic mode (i.e., the modulation frequency for light) and the aperture size. For example, for a 1 cm aperture, the resulting modulation frequency for a resonant photoelastic modulator using silica (silicon dioxide) as the completely isotropic interaction medium is approximately 50 kHz.

### SUMMARY

We describe a fundamentally new way of constructing resonant acousto-optic modulators to achieve pure polarization modulation (and thus high acceptance angle) by relying on optically isotropic materials that exhibits the piezoelectric effect. Specifically, materials belonging to the cubic crystal system are optically isotropic and can exhibit the piezoelectric effect. For example, some materials belonging to the cubic crystal system with point group 4̅3m (also referred to as the zincblende structure, and known as the point group hextetrahedral) or 23 (also known as the point group tetartoidal) are optically isotropic and piezoelectric (e.g., gallium arsenide, gallium phosphide, silicon carbide, and gallium nitride). Using such materials, it is possible to construct highly efficient photoelastic modulators to achieve megahertz level modulation resonant frequencies with centimeter square scale apertures by relying on a collinear interaction geometry between the acoustic wave and the optical beam (since for some cubic crystals collinear interaction between the acoustic wave and the optical beam results in large polarization modulation). Rather than relying on a transverse interaction medium as is typically used for photoelastic modulators, our approach relies on collinear acousto-optic interaction in an optically isotropic and piezoelectric medium. The collinear interaction nature of this modulator allows for simultaneously large input apertures and resonant frequencies, since the resonant frequency is determined by the thickness of the photoelastic material, whereas the active aperture of the modulator is determined by the radius of the transparent surface electrodes. Rather than having a separate piezoelectric transducer bonded to an optically isotropic photoelastic material, in our approach a single photoelastic material functions as both the piezoelectric transducer and the photoelastic interaction medium.

Our approach offers three significant advantages compared to state of the art free-space acousto-optic modulators that can attain a large acceptance angle:
1) The manufacturing process is simple, resulting in low production costs. Rather than bonding two different materials together (a piezoelectric transducer bonded to an optically isotropic photoelastic interaction medium), our approach only requires the deposition of transparent electrodes on the top and bottom surfaces of a photoelastic material with some predetermined cut (e.g., a cut of a 4̅3m cubic crystal shaped into the form of a wafer), significantly simplifying the manufacturing process of the modulators.
2) Typical photoelastic (or acousto-optic) modulators with high acceptance angle have thicknesses that are several centimeters, resulting in bulky designs. Our approach has the same (if not larger) aperture while having a thickness of several hundred microns, resulting in more than 100 times reduction in the weight of the modulator.
3) While exhibiting smaller form factor and easier fabrication, our approach also offers superior performance in modulation frequency and modulation efficiency. The resonant frequency is approximately 100 times higher for an input aperture of 1 cm in diameter, while having a modulation efficiency (normalized to operating frequency) of a factor of more than 100.

To summarize, our approach offers more than two orders of magnitude improvement in each of the following metrics compared to typical photoelastic modulators: modulation frequency, modulation efficiency, and form factor.

### BRIEF DESCRIPTION OF THE DRAWINGS

FIG. 1 shows an exemplary embodiment of the invention.

FIGS. 2A-D show geometry and characterization results for a design example.

FIGS. 3A-B show an example of dependence of modulator performance parameters on crystal cut angle.

FIG. 4 defines several symbols for the modulation analysis.

FIG. 5 schematically shows an example of a controller for closed-loop control of modulation frequency.

FIG. 6 shows an example of anti-reflection coating on the transparent electrodes of a modulator.

FIG. 7 shows an example of several modulators having different window thicknesses disposed in front of an image detector.

### DETAILED DESCRIPTION

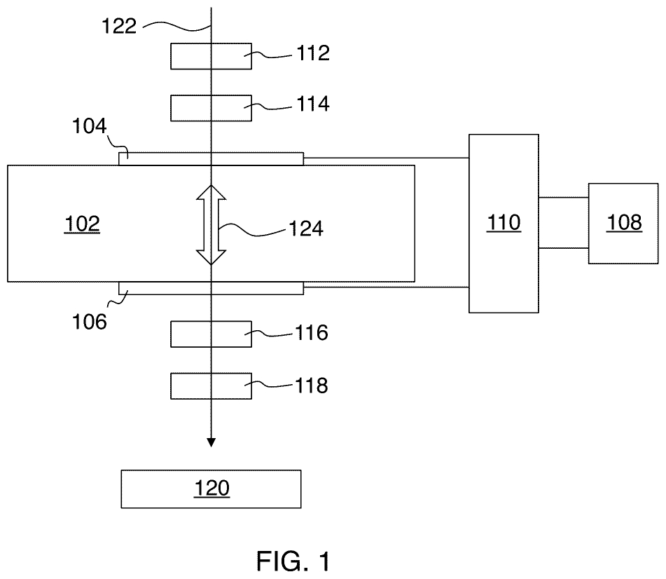

FIG. 1 shows an example of a modulator and optional elements to form an optical system. The modulator includes a suitable photoelastic material 102 with thickness L, transverse dimension d, coated on top and bottom surfaces with transparent electrodes (104 and 106). The modulator is driven with an RF controller 108 (with an optional impedance matching network 110) that is frequency adjustable to excite one of the fundamental acoustic modes in the modulator determined by the thickness L. This sets up an acoustic standing wave 124 in the photoelastic material, that is then used to modulate light 122 propagating through the photoelastic material via the photoelastic effect. Optionally, polarizers 112 and 118 could be placed before and after the modulator, and an image sensor 120 could be used to detect the polarization modulated (or intensity modulated) light that has propagated through the modulator. Other possible optional components include wave plates (e.g., quarter wave plates) 114 and 116. The impedance matching network 110 could contain inductors, capacitors, resistors, transformers, and/or transistors.

Significant features of embodiments include the following, in any combination:
1. A photoelastic material that belongs to the cubic crystal system and is piezoelectric, and optically transparent for some optical wavelengths. The photoelastic material has a thickness of L, with lateral dimensions substantially larger than L.
2. The photoelastic material is coated on top and bottom surfaces with transparent conductive electrodes (for example, indium tin oxide).
3. An RF source is connected to the top and bottom surface electrodes of the photoelastic material to excite one of the acoustic resonances of the modulator through the piezoelectric effect, with the resonant frequencies determined by the thickness L. Preferably, the fundamental shear resonance mode of the modulator is excited.
4. Light travels through this modulator perpendicular (or nearly perpendicular) to the plane of the material, and experiences acousto-optic interaction. Collinear acousto-optic interaction takes place between the light wave and the acoustic wave.
5. The cut angle of the photoelastic material is preferably chosen so that the acoustic wave scatters light into the same polarization as the incident light wave traveling through the modulator (but at a different temporal frequency, where the frequency difference is equal to the RF drive frequency).

The lateral dimensions of the window can be greater than 2 mm and less than 20 cm. In a specific implementation, the photoelastic material is shaped into a window (or wafer) (i.e., a cylindrical geometry with height/thickness less than the lateral dimensions). The thickness of the window is preferably greater than 50 μm and less than 1 cm, and more preferably between 100 μm and 2 mm.

The photoelastic material of window 102 belongs to the cubic crystal system with point group 4̅3m or 23, and is preferably gallium arsenide, gallium phosphide, gallium nitride, zinc sulfide, zinc selenide, or silicon carbide (or a combination of these materials), which are undoped.

### Basic Interaction Geometry

The modulator includes a material belonging to the cubic crystal system with point group 4̅3m or 23 that is optically transparent and coated on top and bottom surfaces with transparent surface electrodes. A suitable cut angle is chosen for the photoelastic material so that one of the fundamental acoustic resonances could be excited efficiently. Ideally, the fundamental shear acoustic mode of the wafer is excited through the transparent electrodes.

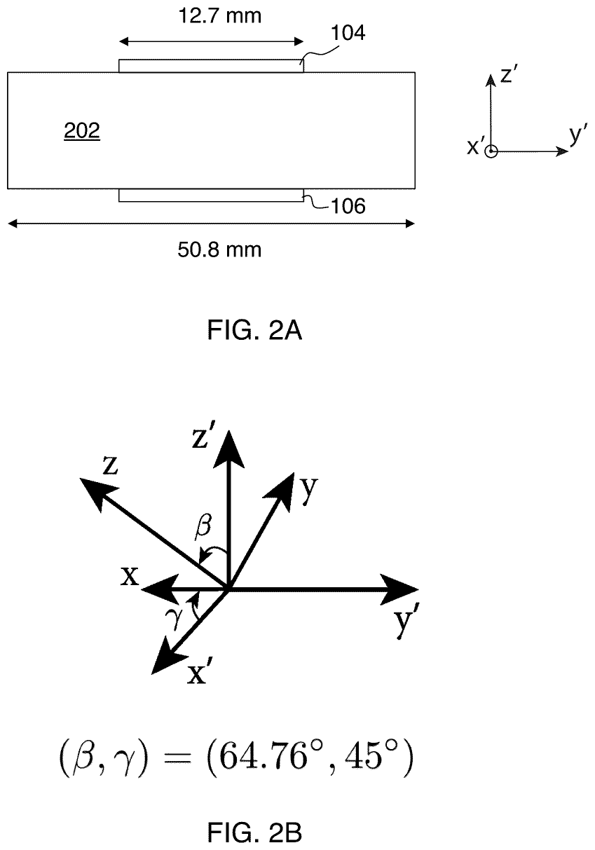

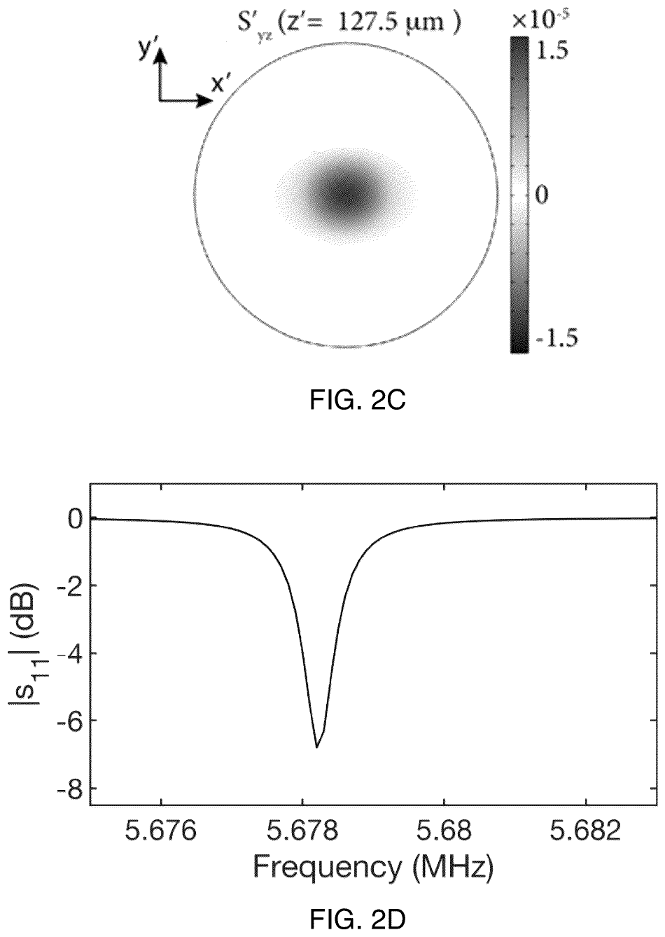

One such modulator construction is shown in FIG. 2A, where a gallium arsenide wafer 202 of thickness 0.25 mm and diameter 50.8 mm is coated on top and bottom surfaces with electrodes having a diameter of 12.7 mm (and centered on the top and bottom surfaces of the wafer). An RF source is connected to the electrodes to drive the modulator using the piezoelectric effect. The fundamental shear resonant frequency for this specific modulator appears around 5.68 MHz, where the dominant shear strain amplitude profile is shown in FIG. 2C when driven with 2Vₚₚ through the RF source, and assuming the modulator has a quality factor equal to 10,000. FIG. 2D shows the magnitude of the s₁₁ scattering parameter with respect to 50Ω, where the dip corresponds to the fundamental shear acoustic mode of the modulator.

### Crystal Cut Angle

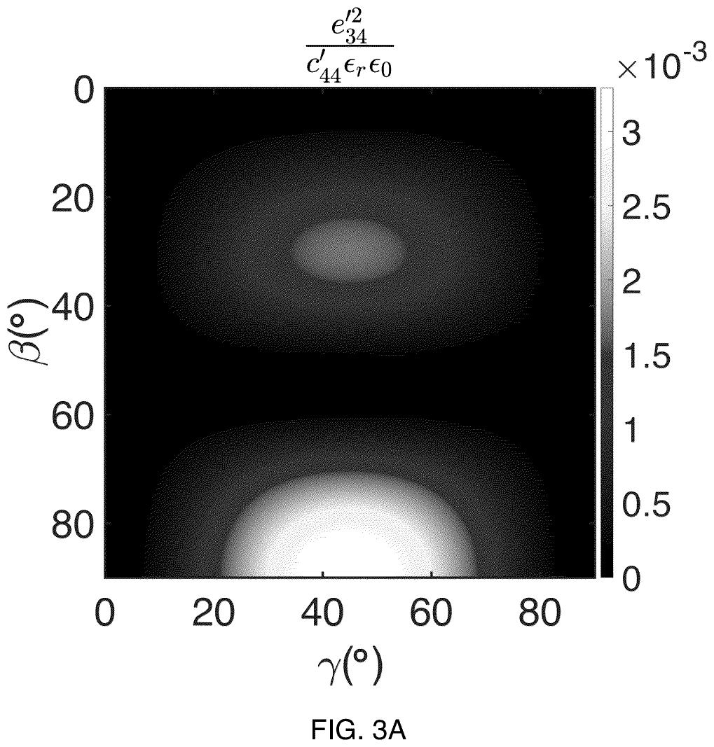

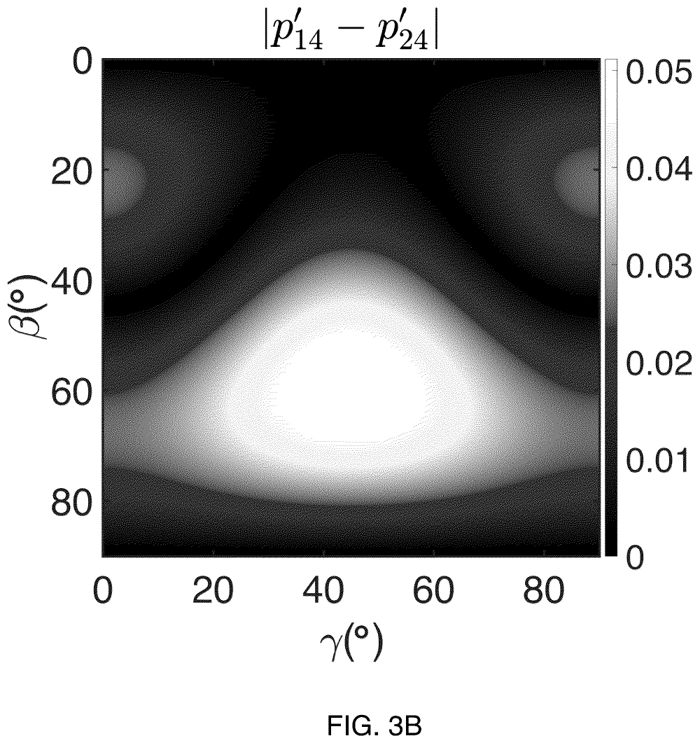

FIG. 2B shows the crystal cut angle for this design example in GaAs. FIGS. 3A-B show further details relating to the crystal cut angle in this example. The cut angle of the modulator is important because it determines both the electromechanical and the acousto-optic properties of the modulator, since the single crystal functions as both the piezoelectric transducer and the photoelastic interaction medium. The chosen cut angle should accommodate coupling to the appropriate strain via piezoelectricity, while also maximizing the difference in phase modulation between the two excited eigenpolarizations in the modulator to achieve the largest polarization modulation. We choose to operate the modulator by exciting S_{yz}′ shear strain, as shear modes typically have lower acoustic loss compared to longitudinal modes. If we assume only S_{yz}′ strain is excited in the modulator, the BVD equivalent resistance is expressed in Eq. (A), where primed notation indicates representation in the rotated coordinate frame (x′, y′, z′), (x, y, z) is the coordinate frame of the crystal, c₄₄′ is the rotated stiffness coefficient, e₃₄′ is the rotated piezoelectric stress constant, fᵣ is the resonant frequency of the dominant S_{yz}′ strain mode, and Q is the quality factor for the operating strain mode. In the primed tensor notation, wᵢⱼ′ denotes the element in the ith row and jth column of the rotated w′ tensor. The orientation of the crystal coordinate system with respect to the chosen rotated system is shown in FIG. 2B.

$${R}_{t} \approx \frac{{c}_{44}^{′} L}{2 {f}_{r} {π}^{2} {r}^{2} {e}_{34}^{′2} Q} \qquad ( A )$$

The crystal orientation of GaAs should be selected to maximize |p₁₄′−p₂₄′ | (where p₁₄′ and p₂₄′ are the rotated photoelastic coefficients), while keeping the other relevant photoelastic coefficients pertaining to S_{yz}′ strain small, and also keeping Re at a reasonable value. The variation of the electromechanical coupling coefficient and the effective photoelastic coefficient for polarization modulation as a function of the crystal orientation in Euler angles are shown in FIG. 3A and FIG. 3B, respectively, where εᵣ is the relative permittivity of GaAs and co is the vacuum permittivity.

The electromechanical coupling coefficient is a widely used figure of merit to assess piezoelectric transducers. This is an important parameter when constructing wide bandwidth transducers, as the transduction bandwidth is directly related to the magnitude of this coefficient. For resonant designs, however, a single frequency of operation is needed. The coupling coefficient therefore primarily influences the impedance matching condition for operation at the resonant frequency. The BVD equivalent impedance is usually selected larger than the radio frequency (RF) transmission line impedance in the design stage to make the acoustic and dielectric loss mechanisms of the modulator to dominate parasitic electrical resistances. To couple as much of the RF power carried to the modulator by a transmission line, the BVD equivalent impedance of the modulator is matched to the transmission line impedance. The electromechanical coupling coefficient should also not be too small. Due to non-ideal matching components, an extremely small electromechanical coupling coefficient would result in significant power loss. Notice that standard cuts, such as X-cut ((β, γ)=(90°, 90°)), Y-cut ((β, γ)=(90°, 0°)), and Z-cut ((β, γ)=(0°, 0°)) do not have sufficient electromechanical coupling to be useful (see FIG. 3A).

Before choosing the crystal orientation, we need to have a guess on the Q for the desired mode. Based on previous devices fabricated using lithium niobate, which had Q values in the range of 1,000 to 30,000, we choose the crystal orientation as (β, γ)=(64.76°, 45°), which is equivalent to (β, γ) in Miller indices notation. The Euler angles (β, γ)=(64.76°, 45°) relate the rotated system (x′, y′, z′) to the crystal coordinate system (x, y, z). This cut angle has large photoelastic coupling (as seen in FIG. 3B), as well as keeping Rₜ between approximately 30Ω and 1 kΩ for expected Q values.

### Modulation

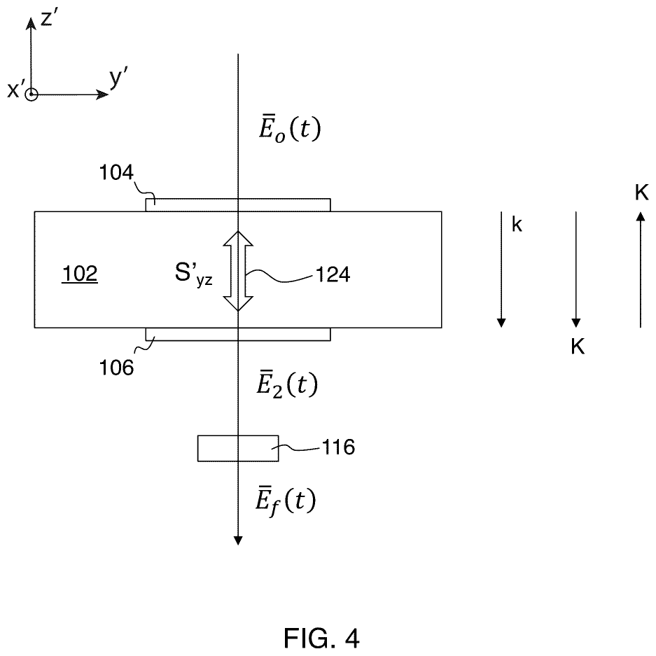

Large strains could be generated inside the modulator when driven at the fundamental shear resonance frequency, which can then be used to modulate the polarization of light propagating through the modulator. FIG. 4 shows a simplified collinear acousto-optic interaction for such a modulator. If an acoustic standing wave 124 is set up in the photoelastic material 102 (here S_{yz}′ strain is excited) with wavevector K, it could be used to modulate the polarization of light propagating through the modulator with wavevector k. Optionally, a polarizer 118 could be placed after the modulator to convert the polarization modulation of light into intensity modulation. Input electric field vector is Ēₒ(t) for light, as shown in Eq. (1), where λₒ is the electric field amplitude, w_{L} is the angular frequency of the light, t is the time, j is the imaginary unit with j²=−1, k=2π/λ₀ is the optical wavevector with λₒ being the vacuum wavelength for the light, the light wave propagates in the local coordinate system with unit vectors (âₓ, â_{y}, â_{z}), and c.c. stands for the complex conjugate.

$${\overline{E}}_{o} ( t ) = \frac{1}{2} {A}_{o} ( {{\hat{a}}^{′}}_{x} {e}^{j ( {w}_{L} t - {kz}^{′} )} + {{\hat{a}}^{′}}_{y} {e}^{j ( {w}_{L} t - {kz}^{′} )} ) + c . c . {\vert}_{{z}^{′} = 0} \qquad ( 1 )$$

The electric field of the light after propagating through the modulator and interacting with the acoustic standing wave is represented by Ē₂(t) and is expressed in Eq. (2), where λₙ(z′) and Bₙ(z′) are related to each other through the coupled-mode equations as shown in Eq. (3), where nₒ is the refractive index of the photoelastic material, p′₁₄ and p′₂₄ are the relevant photoelastic tensor components relating the modal amplitudes in the local coordinate frame, wᵣ=2πfᵣ (where the modulator is driven at frequency fᵣ using the RF source to excite the fundamental resonance shear mode of the modulator), K is the wavevector for the excited acoustic field in the photoelastic material via the piezoelectric effect, and S′_{yz} is the amplitude of the acoustic standing wave excited in the photoelastic material. To simplify the expressions, it is assumed that the strain amplitude distribution is constant throughout the photoelastic material and equal to S′_{yz}. In deriving these relations between the mode amplitudes, the slowly-varying envelope approximation was made.

$${\overline{E}}_{2} ( t ) = \frac{{{\hat{a}}^{′}}_{x}}{2} {\sum }_{n = - ∞}^{∞} {A}_{n} ( {z}^{′} ) {e}^{j ( ( {w}_{L} + {nw}_{r} ) t - {kz}^{′} )} + \frac{{{\hat{a}}^{′}}_{y}}{2} {\sum }_{n = - ∞}^{∞} {B}_{n} ( {z}^{′} ) {e}^{j ( ( {w}_{L} + {nw}_{r} ) t - {kz}^{′} )} + c . c . \qquad ( 2 )$$

$$\frac{d}{{dz}^{′}} {A}_{n} ( {z}^{′} ) = \frac{- 2 {jn}_{o}^{3} {p}_{14}^{′} {S}_{yz}^{′} πsin ( {Kz}^{′} )}{{λ}_{o}} ( {A}_{n - 1} ( {z}^{′} ) + {A}_{n + 1} ( {z}^{′} ) ) , ∀ n ∈ ℤ \qquad ( 3 )$$

$$\frac{d}{{dz}^{′}} {B}_{n} ( {z}^{′} ) = \frac{- 2 {jn}_{o}^{3} {p}_{24}^{′} {S}_{yz}^{′} πsin ( {Kz}^{′} )}{{λ}_{o}} ( {B}_{n - 1} ( {z}^{′} ) + {B}_{n + 1} ( {z}^{′} ) ) , ∀ n ∈ ℤ$$

The electric field for the light is expressed as Ē_{f}(t) after propagating through the polarizer and expressed in Eq. (4), with transmission axis \hat{t} as expressed in Eq. (5).

$${\overline{E}}_{f} ( t ) = \hat{t} ( \frac{\hat{t} \cdot {{\hat{a}}^{′}}_{x}}{2} {\sum }_{n = - ∞}^{∞} {A}_{n} ( {z}^{′} ) {e}^{j ( ( {w}_{L} + {nw}_{r} ) t - {kz}^{′} )} + \frac{\hat{t} \cdot {{\hat{a}}^{′}}_{y}}{2} {\sum }_{n = - ∞}^{∞} {B}_{n} ( {z}^{′} ) {e}^{j ( ( {w}_{L} + {nw}_{r} ) t - {kz}^{′} )} ) + c . c . \qquad ( 4 )$$

$$\hat{t} = \frac{{{\hat{a}}^{′}}_{x} + {{\hat{a}}^{′}}_{y}}{\sqrt{2}} \qquad ( 5 )$$

The intensity of the light that has propagated through the polarizer is expressed in Eq. (6) as I_{f}(t), where J₀ and J₂ are the zeroth and second order Bessel functions of the first kind, respectively, HOH stands for the higher order harmonics, ϕₛ is the static phase shift of light equal to zero (since the photoelastic material is optically isotropic, and therefore does not exhibit optical birefringence), and ϕ_{D} is the dynamic phase shift of light as expressed in Eq. (8). The drive power for the RF source can be used to adjust the acoustic standing wave amplitude S′_{yz}, which subsequently controls the dynamic phase ϕ_{D}, and therefore the amplitude of polarization modulation for light. Consequently, the RF drive power is used to control the amount of polarization modulation imparted on light propagating through the modulator.

$${I}_{f} ( t ) = {\vert {\overline{E}}_{f} ( t ) \vert}^{2} \approx \frac{\vert {A}_{o}^{2} \vert}{2} ( \frac{1}{2} + \frac{1}{2} [ cos ( {ϕ}_{s} ) ( {J}_{0} ( {ϕ}_{D} ) - 2 cos ( {ϕ}_{s} ) {J}_{2} ( {ϕ}_{D} ) cos ( 4 π {f}_{r} t ) + HOH ) ] ) \qquad ( 6 )$$

$${ϕ}_{s} = 0 \qquad ( 7 )$$

$${ϕ}_{D} = \frac{2 {πLn}_{o}^{3} {S}_{yz}^{′} ( {p}_{14}^{′} - {p}_{24}^{′} )}{{λ}_{o}} \qquad ( 8 )$$

One interesting property of this modulator is the intensity modulation frequencies imparted on light that has propagated through the modulator. The modulator is driven using an RF source with frequency fᵣ, however, the intensity of light is only modulated at the even harmonic frequencies of fᵣ (when a polarizer is placed after the modulator). This is because the material is optically isotropic, leading to ϕₛ=0, and consequently only the even harmonics show up in the intensity of light. The RF drive power driving the modulator could be chosen such that the second harmonic term is dominant in the intensity of light (cos(4πfᵣt)).

In one experimental investigation of a GaAs modulator, the RF modulation frequency was 6 MHz, the input aperture diameter was 1 cm, the thickness was roughly 0.25 mm, the acceptance angle was +/−30 degrees and the modulation efficiency exceeded 50% for a drive power of 1 W. This is a 50× improvement in modulation frequency and a significant reduction in modulator thickness compared to the conventional state of the art.

### RF Control Options

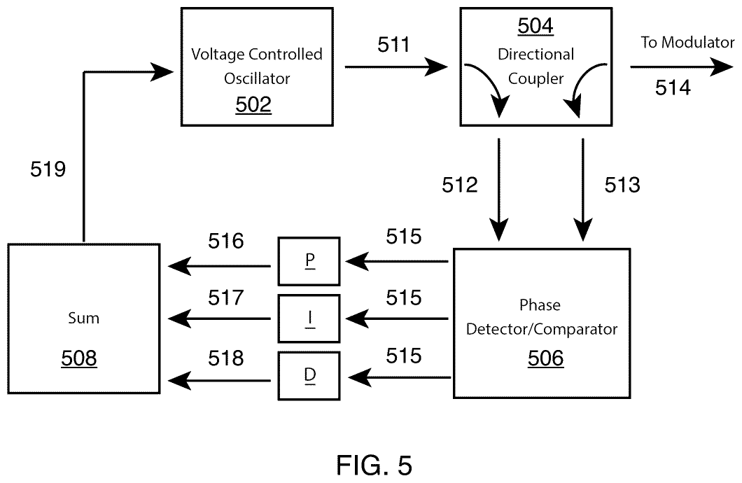

FIG. 5 shows an exemplary implementation method for the RF controller driving the acousto-optic modulator to track the resonant frequency. A voltage controlled oscillator 502 outputs an RF tone 511 which is sent to a directional coupler 504. The directional coupler has an output coupling port 514 that sends the majority of the RF power to the acousto-optic modulator. A part of the input RF power 511 is coupled directly into 512, whereas the reflected RF power from the acousto-optic modulator (due to impedance mismatch between the RF source impedance and modulator equivalent circuit impedance) is coupled into 513. The coupled power outputs of the directional coupler (512 and 513) are input into a phase detector/comparator 506 that computes (either in analog or digital circuit implementation) the phase difference 515 between the RF waveforms (512 and 513). This computed phase difference is sent into (any or all of) three different units to implement a multiplication (P), integration (I), and differentiation (D) control. The outputs from these units (516, 517, 518, respectively) are then summed up (either in analog or digital format) by a summer 508, and fed back into the input port 519 of the voltage controlled oscillator 502 to adjust the RF frequency of 511 that is the output of the voltage controlled oscillator.

The above implementation for the RF controller (as shown in FIG. 4) is one specific implementation method, where closed-loop feedback (using a PID control loop) is used to adjust the RF frequency being sent to the modulator as a function of time (to track the resonant frequency). Temperature changes can occur due to environmental changes in temperature and due to the RF source driving the modulator (and therefore heating the modulator). Temperature change subsequently results in a change in the mechanical resonant frequencies of the modulator. Closed loop control as in this example is one way to compensate for such temperature effects. The above implementation method relies on the changes in the reflected phase of the RF power sent into the modulator due to changes in the mechanical resonant frequencies of the modulator. Other types of methods to track the resonant frequency of the modulator, and thus adjust the RF drive frequency could be used as well.

### Variations

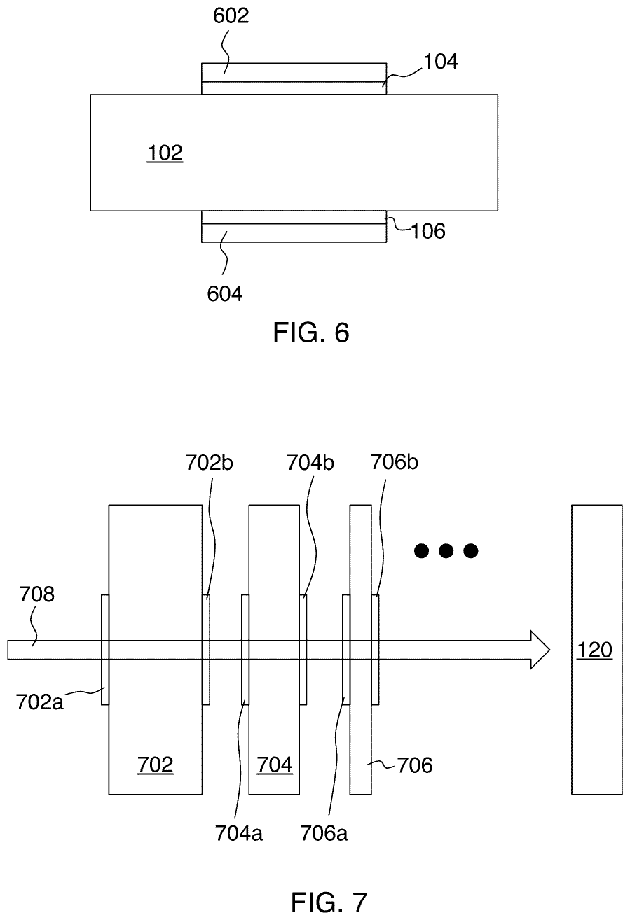

FIG. 6 shows a variation where antireflection (AR) coatings 602 and 604 are disposed on transparent electrodes 104 and 106, respectively. Alternatively, the transparent electrodes could also be disposed on top of the antireflection coatings (order could be changed). Typically, such AR coatings are made with suitable multilayer dielectric stack structures, as is well known in the art.

FIG. 7 shows a variation where several modulators 702, 704, 706, each having a different thickness, are disposed in front of an image detector 120. Light 708 reaches detector 120 by passing through each of the modulators. Each modulator is driven at its resonant frequency via corresponding transparent electrodes (e.g., electrodes 702a,b for modulator 702, electrodes 704a,b for modulator 704, and electrodes 706a,b for modulator 706). Thus the light received at detector 120 is typically modulated at several distinct frequencies.

1. An optical modulator comprising:
a window having opposite top and bottom surfaces separated by a thickness, wherein a material of the window is both optically isotropic and piezoelectric;
wherein lateral dimensions of the window are substantially greater than the thickness;
a top transparent electrode disposed on the top surface of the window;
a bottom transparent electrode disposed on the bottom surface of the window;
a controller electrically connected to the top and bottom transparent electrodes and configured to generate an acoustic standing wave in the active material via its piezoelectric effect;
wherein the acoustic standing wave provides optical modulation of light passing through the window via the photoelastic effect.

2. The modulator of claim 1, wherein the material of the window has point group 4̅3m (hextetrahedral) or 23 (tetartoidal).

3. The modulator of claim 2, wherein the material is selected from the group consisting of: gallium arsenide, gallium phosphide, gallium nitride, zinc sulfide, zinc selenide, and silicon carbide.

4. The modulator of claim 1, wherein the acoustic standing wave is the fundamental shear resonance mode of the window, and wherein a frequency of the acoustic standing wave is determined by the thickness of the window.

5. The modulator of claim 1, wherein a cut angle of the window is chosen such that light scattered by the acoustic standing wave is co-polarized with incident light.

6. The modulator of claim 1, wherein the controller is configured to provide a DC voltage bias to the window, whereby a static birefringence is generated in the window.

7. The modulator of claim 1, wherein the controller is configured to automatically adjust an input RF frequency to the window to match an acoustic resonance of the window.

8. The modulator of claim 1, wherein the top and bottom electrodes are transparent in an operating wavelength range, and wherein the operating wavelength range is part or all of a wavelength range from 300 nm to 10 μm.

9. The modulator of claim 1, further comprising at least one anti-reflection coating disposed on at least one surface of the window.

10. The modulator of claim 1, further comprising a quarter-wave plate disposed before or after the window.

11. The modulator of claim 1, further comprising at least one polarizer disposed before and/or after the window.

12. The modulator of claim 1, further comprising an image sensor.

13. A multi-frequency sensor including:
an image sensor and two or more modulators according to claim 1 and having distinct window thicknesses;
wherein incident light passes through each of the two or more modulators according to claim 1 to reach the image sensor;
whereby each of the two or more modulators according to claim 1 imparts a distinct modulation frequency on light received by the image sensor.

14. The modulator of claim 1, wherein the thickness of the window is in a range from 0.1 mm to 10 mm.
